(19) United States
(12) Patent Application Publication
(10) Pub. No.: US 2006/0085256 A1
(43) Pub. Date: Apr. 20, 2006

(54) Clip'n win! couponing marketing system

(76) Inventor: Robert William Fleming, Rolla, MO (US)

Correspondence Address: Robert William Fleming, 415 Williams Rd., Rolla, MO, 65401, US

(21) Appl. No.: 11/239,949

(22) Filed: Sep. 30, 2005

Related U.S. Application Data
(60) Provisional application No. 60/615,769, filed on Oct. 4, 2004.

(51) Int. Cl. G06Q 30/00

(52) U.S. Cl. 705/14

(57) ABSTRACT

The integration of a puzzle within a coupon marketing environment using traditional print and/or digital media as a distribution vehicle, or some combination thereof. By using such an approach, the user is further motivated to proactively participate in the coupon marketing experience due to the desire to assemble the puzzle and, in some cases, use the information to enter a contest or take part in another event. The invention can be applied to coupon marketing environments of unlimited variety, including single and multiple coupons, as well as wide variety of puzzles that motivate the consumer to participate. The value of this coupon marketing process is to provide a more effective way for marketers to capture the user's attention and get their coupon offer in the user's possession and/or used digitally in an electronic environment.

### CROSS-REFERENCE TO RELATED APPLICATIONS

This utility patent application references provisional patent application No. 60/615,769, filed on Oct. 4, 2004 by Robert William Fleming, 415 Williams Rd., Rolla, Mo. 65401.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The current methods used to motivate users to actively participate in coupon-oriented marketing methods are effective, but industry statistics clearly indicate the redemption rates of such marketing systems are not remarkable.

This invention, by integrating challenging puzzles and optional related contests as part of the motivational mechanism, offers marketers an innovative coupon marketing system that more effectively gains the user's attention and motivates the user to proactively participate in the coupon redemption process.

This marketing system has applications including, but not limited to, traditional print and/or digital media (including the Internet and email) and combinations thereof.

In discussing this marketing system, a “coupon” is used as a generic term to define any particular offer being made by the merchant or service provider that uses this system to gain a consumer's attention, including, but not limited to, price discounts and special offers.

In discussing this marketing system, a “puzzle” is used as a generic term to define any particular mechanism designed to motivate the user to assemble the puzzle and use the information to further participate in another activity.

### BRIEF SUMMARY OF THE INVENTION

When a user is presented a typical coupon offer—whether presented using print and/or some form of digital media (including, but not limited to, the Internet and email applications)—the user is motivated to actively participate in the coupon process via marketing information on the coupon itself and/or surrounding the coupon. Therefore, unless the user is motivated to clip out the coupon due to these traditional marketing techniques, they are highly unlikely to participate.

This invention, by integrating a challenging puzzle (the word “puzzle” has a broad meaning and refers to anything that provides the user with an experience that motivates them to participate) with the coupon(s) offer, either surrounding the coupon(s) or part of the coupon(s) themselves using print, digital or a combination of these media platforms, motivates the user to participate in order to assemble the puzzle and, in some cases, have the opportunity to participate in a contest or drawing.

The intuitive value of this invention to marketers is found in its effectiveness in overcoming the challenge of getting coupons from the delivery mechanism into the user's possession, overcoming a significant barrier to the effectiveness of coupon-based marketing techniques.

### BRIEF DESCRIPTION OF SEVERAL VIEWS OF THE DRAWING

FIG. 1 is an example of the invention where a single coupon offer is surrounded by several puzzle pieces. The consumer, motivated to clip out the six puzzle pieces (designated as items a through f), assembles the puzzle pieces, and solves the puzzle. After doing so, the user now has the coupon (designated as item g) in their possession. This drawing is one example of a single coupon environment that can be applied to print, digital media, telephony or any combination of delivery mechanisms designed to convey the invention's marketing system to the user.

FIG. 2 is an example of the invention where multiple coupons are integrated with multiple puzzle pieces. As in the FIG. 1 example, when the user is done clipping out the puzzle pieces (items a through h), they end up with coupons (items i through p) in their hands. This example, like FIG. 1, is designed to provide only one version of an unlimited number of ways to present the invention's marketing system to the consumer. Also, this drawing's example, as with FIG. 1, may be applied to a single media format or combination of media—including, but not limited to print, digital, telephony—to deliver the coupon marketing system to the user.

### DETAILED DESCRIPTION OF THE INVENTION

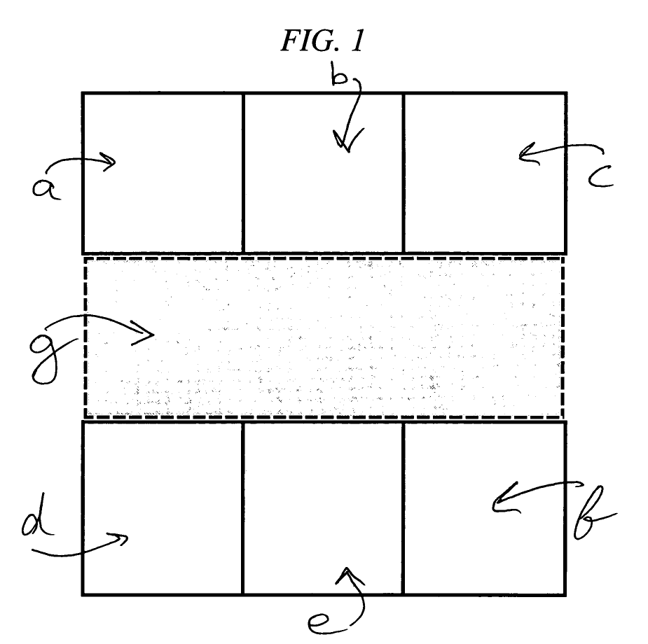

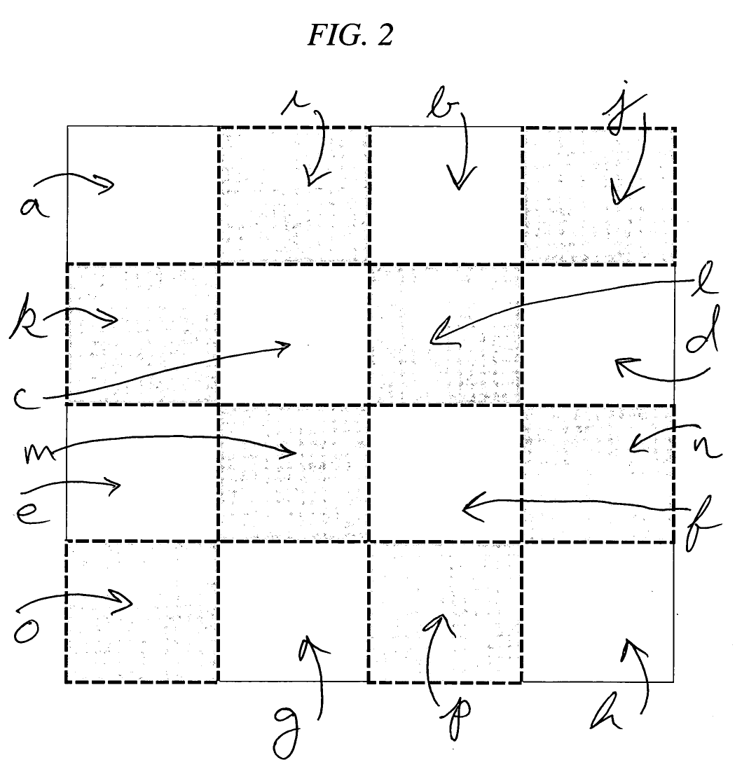

The invention was created to provide a more effective system of delivering coupon-based marketing to users. The typical, traditional coupon marketing approach relies on attracting a user's attention via marketing messages that are part of or adjacent to a coupon. This invention, as depicted in the FIGS. 1 and 2 examples, integrates a single coupon (FIG. 1) or multiple coupons (FIG. 2) with puzzle items. The user is now motivated to physically clip out the puzzle items (or digitally interact with them) in order to determine the information to be found in the puzzle. When finished, the user has separated the coupon (or coupons) from the puzzle items, a critical positive step toward getting the user to actually redeem the coupon, whether via physical or digital presentation methods.

The “better mousetrap” this invention offers is quite intuitive, as the process itself reveals the power of the invention. The user, after being motivated to participate in the puzzle assembly process, literally clips out the coupons by default (or digitally reveals the coupons by default).

In addition to the invention's value in overcoming the problem of getting coupons from the delivery mechanism into the user's possession, it also provides additional eyeball “stickiness” for the coupon marketer's message, as well as the opportunity to work in conjunction with other marketers who wish to share the same space and the related cost. FIG. 2 provides an example format where several different marketers could share the same delivery system to present their messages.

Finally, the opportunity to use this invention via an infinite number of combinations of various media (print, digital, telephony . . . to name a few) provides the marketer a powerful new tool to interface their message or messages using a coupon-based approach, capitalizing on the efficiency of such multimedia campaigns.

1. Integration of a puzzle within a print and/or digital coupon delivery mechanism, or some combination thereof, that motivates the user (or users) to proactively participate in the coupon redemption process due to their motivation to assemble the puzzle and possibly use the puzzle's information to participate in another activity, including but not limited to a contest.
